(19) United States
(12) Patent Application Publication
(10) Pub. No.: US 2025/0080000 A1
(43) Pub. Date: Mar. 6, 2025

(54) BRIDGE SWITCHING CONVERTER AND ASSOCIATED CONTROLLER

(71) Applicant: Chengdu Monolithic Power Systems Co., Ltd., Chengdu (CN)

(72) Inventor: Yu Zhang, Hangzhou (CN)

(21) Appl. No.: 18/818,400

(22) Filed: Aug. 28, 2024

(30) Foreign Application Priority Data
Sep. 1, 2023 (CN) 202311129510.4

(51) Int. Cl. H02M 3/335

(52) U.S. Cl. CPC H02M 3/33573; H02M 3/33576

(57) ABSTRACT

A bridge switching converter has a transformer, a primary switching circuit having a first switch and a second switch, and a controller. A first bridge terminal is coupled to a first terminal of a primary winding of the transformer, and a second bridge terminal is coupled to a second terminal of the primary winding. A center-tap of a secondary winding of the transformer is coupled to the second input terminal of the primary switching circuit. The second switch is coupled between the first bridge terminal and an output node, and the first switch is coupled between an input node and the first bridge terminal. When the first switch remains off, the controller turns on the second switch based on the output voltage, and when the second switch remains off, the controller turns on the first switch based on the output voltage.

### CROSS-REFERENCE TO RELATED APPLICATIONS

This application claims the benefit of CN application No. 202311129510.4, filed on Sep. 1, 2023, and incorporated herein by reference.

### BACKGROUND OF THE INVENTION

### 1. Field of the Invention

The present invention generally refers to electrical circuits, and more particularly but not exclusively refers to bridge switching converter.

### 2. Description of Related Art

A bridge switching converter is an electrical circuit that receives an input voltage to a regulated output voltage. The output voltage is lower than the input voltage in the case of a step-down converter, whereas the output voltage is higher than the input voltage in the case of a step-up converter. Bridge switching converters are employed in a variety of devices, including computers, smart phones, etc. With the push for more energy efficient and smaller devices, there is a need for bridge switching converters that have high efficiency and low cost, and allow for high printed circuit board (PCB) density. A bridge switching converter may employ a transformer to scale or isolate a voltage presented on the primary winding of the transformer.

### SUMMARY OF THE INVENTION

It is an object of the present invention to provide a bridge switching converter and associated integrated circuit (IC) as a controller of the bridge switching converter.

One embodiment of the present invention discloses a bridge switching converter. The bridge switching converter comprises an input node, an output node, a transformer, a first to sixth switches each having a first terminal and a second terminal, and a controller. The input node is configured to receive an input voltage. The output node is configured to provide an output voltage. The transformer has a primary winding and a secondary winding. Each of the primary winding and the secondary winding has a first terminal and a second terminal. The secondary winding further has a center-tap positioned between the first and second terminals of the secondary winding, and the center-tap is coupled to the output node. The first terminal of the first switch is coupled to the input node, and the second terminal of the first switch is coupled to the first terminal of the primary winding. The first terminal of the second switch is coupled to the second terminal of the first switch and the first terminal of the primary winding, the second terminal of the second switch is coupled to the center-tap of the secondary winding, and the first switch and the second switch forms a first bridge branch. The first terminal of the third switch is coupled to the input node, and the second terminal of the third switch is coupled to the second terminal of the primary winding. The first terminal of the fourth switch is coupled to the second terminal of the third switch and the second terminal of the primary winding, the second terminal of the fourth switch is coupled to the center-tap of the secondary winding, and the third switch and the fourth switch forms a second bridge branch. The first terminal of the fifth switch is coupled to the first terminal of the secondary winding, and the second terminal of the fifth switch is coupled to a reference node. The first terminal of the sixth switch is coupled to the second terminal of the secondary winding, and the second terminal of the sixth switch is coupled to the reference node. The controller is configured to provide a first switching control signal to control the second and third switches, provide a second switching control signal to control the first and fourth switches, provide a third switching control signal to control the fifth switch, and provide a fourth switching control signal to control the sixth switch. When the first and fourth switches are off, the controller is configured to turn on the second and third switches based on the output voltage via the first switching control signal, and the controller is configured to turn off the second and third switches until an ON-time period of the third switch or an ON-time period of the fourth switch reaches a first time period. When the second and third switches are off, the controller is configured to turn on the first and fourth switches based on the output voltage via the second switching control signal, and the controller is configured to turn off the first and fourth switches until an ON-time period of the first switch or an ON-time period of the fourth switch reaches a second time period.

Another embodiment of the present invention discloses a bridge switching converter. The bridge switching converter comprises an input node, an output node, a reference node, a transformer, a primary switching circuit, and a controller. The bridge switching converter is configured to receive an input voltage between the input node and the reference node, and is configured to provide an output voltage between the output node and the reference node. The transformer has a primary winding and a secondary winding. The primary winding has a first terminal and a second terminal. The secondary winding has a first terminal, a second terminal, and a center-tap positioned between the first and second terminals of the secondary winding. The primary switching circuit has a first input terminal, a second input terminal, a first bridge terminal, a second bridge terminal, a first switch, and a second switch. The first input terminal of the primary switching circuit is coupled to the input node. The second input terminal of the primary switching circuit is coupled to the output node. The first bridge terminal is coupled to the first terminal of the primary winding. The second bridge terminal is coupled to the second terminal of the primary winding. The center-tap is coupled to the second input terminal of the primary switching circuit. The second switch is coupled between the first bridge terminal and the output node, and the first switch is coupled between the input node and the first bridge terminal. The controller is configured to provide a first switching control signal to control the second switch and provide a second switching control signal to control the first switch based on the output voltage. When the first switch remains off, the controller is configured to turn on the second switch based on the output voltage via the first switching control signal, and when the second switch remains off, the controller is configured to turn on the first switch based on the output voltage via the second switching control signal.

Yet another embodiment of the present invention discloses an IC as a controller of a bridge switching converter. The IC comprises an output voltage sensing pin, an input voltage sensing pin, and a first to fourth control signal output pins. The output voltage sensing pin is configured to receive an output voltage sensing signal representative of an output voltage of the bridge switching converter. The input voltage sensing pin is configured to receive an input voltage sensing signal representative of an input voltage of the bridge switching converter. The first control signal output pin is configured to provide a first switching control signal to control a first switch positioned at a primary side of a transformer of the bridge switching converter. The second control signal output pin is configured to provide a second switching control signal to control a second switch positioned at the primary side of the transformer. The third control signal output pin is configured to provide a third switching control signal to control a third switch positioned at a secondary side of the transformer. The fourth control signal output pin is configured to provide a fourth switching control signal to control a fourth switch positioned at the secondary side of the transformer. When the second switch is off, the IC is configured to turn on the first switch based on the output voltage via the first switching control signal, and the IC is configured to turn off the first switch via the first switching control signal until an ON-time period of the first switch reaches a first time period. When the first switch is off, the IC is configured to turn on the second switch based on the output voltage via the second switching control signal, and the IC is configured to turn off the second switch via the second switching control signal until an ON-time period of the second switch reaches a second time period.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1A schematically illustrates a bridge switching converter 100A in accordance with an embodiment of the present invention.

FIG. 1B schematically illustrates a bridge switching converter 100B in accordance with an embodiment of the present invention.

FIG. 2 schematically illustrates a controller 30 in accordance with an embodiment of the present invention.

FIG. 3A schematically illustrates an ON-time unit 22A in accordance with an embodiment of the present invention.

FIG. 3B schematically illustrates an ON-time unit 22B in accordance with an embodiment of the present invention.

FIG. 4 schematically illustrates a switching control unit 23 in accordance with an embodiment of the present invention.

FIG. 5 schematically illustrates a timing diagram 50 of the switching control unit 23 in accordance with an embodiment of the present invention.

FIG. 6 schematically illustrates a bridge switching converter 200 in accordance with an embodiment of the present invention.

FIG. 7 schematically illustrates a bridge switching converter 300 in accordance with an embodiment of the present invention.

FIG. 8 schematically illustrates a controller 30B in accordance with an embodiment of the present invention.

FIG. 9 schematically illustrates a bridge switching converter 400 in accordance with an embodiment of the present invention.

FIG. 10 schematically illustrates a controller 30C in accordance with an embodiment of the present invention.

FIG. 11 illustrates a control method 500 for a bridge switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

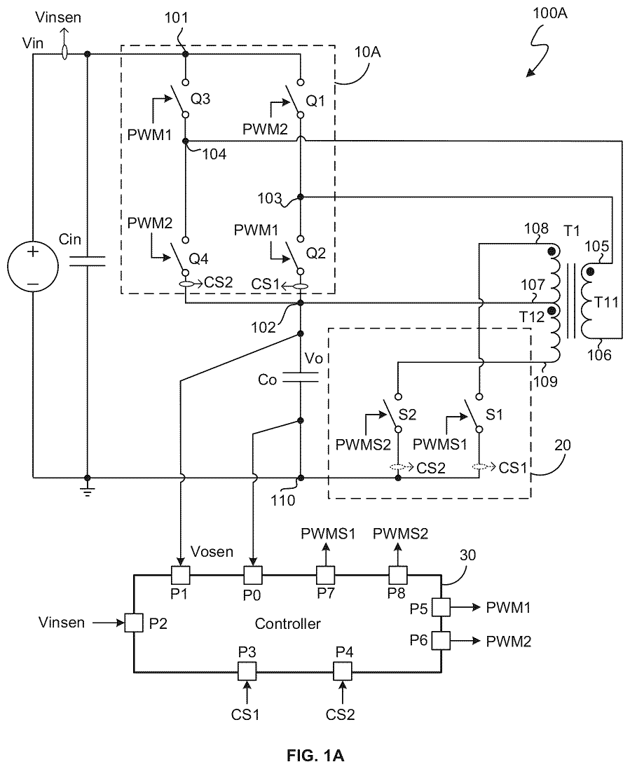

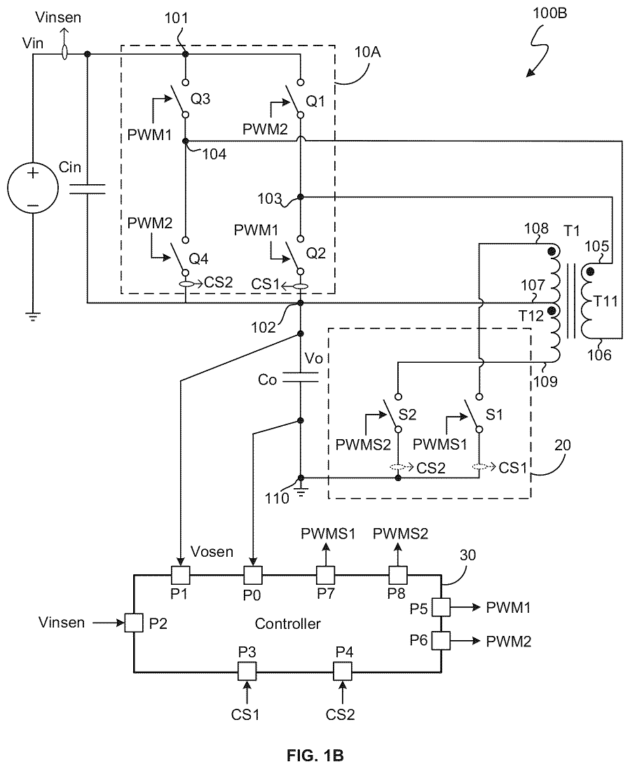

FIG. 1A schematically illustrates a bridge switching converter 100A in accordance with an embodiment of the present invention. The bridge switching converter 100A receives an input voltage Vin at an input node 101, and provides an output voltage Vo at an output node 102. In the embodiment of FIG. 1, the bridge switching converter 100A comprises a transformer T1, a primary switching circuit 10A coupled to a primary winding T11 of the transformer T1, a secondary switching circuit 20 coupled to a secondary winding T12 of the transformer T1, and a controller 30. In one example, the primary switching circuit 10A is a bridge circuit. In the embodiment of FIG. 1, the primary switching circuit 10A is illustrated as a full-bridge circuit as one example. However, one with ordinary skill in the art should also understand that the primary switching circuit 10A may comprise other suitable topology of bridge circuit, such as half-bridge circuit. The bridge switching converter 100A further comprises a reference node 110. An input capacitor Cin is coupled between the input node 101 and the reference node 110. A voltage across the input capacitor Cin is the input voltage Vin. In one embodiment, the reference node 110 is coupled to a reference ground.

In the embodiment of FIG. 1A, the input node 101 serves as an input terminal of the primary switching circuit 10A, and the output node 102 serves as another input terminal of the primary switching circuit 10A. The primary switching circuit 10A further comprises a bridge terminal 103 coupled to a first terminal 105 of the primary winding T11, and a bridge terminal 104 coupled to a second terminal 106 of the primary winding T11. A center-tap 107 of the secondary winding T12 is coupled to the output node 102, and the center-tap 107 is positioned between a first terminal 108 and a second terminal 109 of the secondary winding T12. In the embodiment of FIG. 1A, the primary switching circuit 10A comprises switches Q1-Q4. The switches Q1-Q2 are coupled in series between the input node 101 and the output node 102 to form a bridge branch, and the switches Q3-Q4 are coupled in series between the input node 101 and the output node 102 to form another bridge branch, and each switches Q1-Q4 has a first terminal and a second terminal. The first terminal of the switch Q1 is coupled to the input node 101, and the second terminal of the switch Q1 is coupled to the bridge terminal 103. The first terminal of the switch Q2 is coupled to the second terminal of the switch Q1 and the bridge terminal 103, and the second terminal of the switch Q2 is coupled to the center-tap 107. The first terminal of the switch Q3 is coupled to the input node 101, and the second terminal of the switch Q3 is coupled to the bridge terminal 104. The first terminal of the switch Q4 is coupled to the second terminal of the switch Q3 and the bridge terminal 104, and the second terminal of the switch Q4 is coupled to the center-tap 107. In the embodiment of FIG. 1A, the secondary switching circuit 20 comprises switches S1-S2, each switches S1-S2 has a first terminal and a second terminal. The first terminal of the switch S1 is coupled to the first terminal 108 of the secondary winding T12, and the second terminal of the switch S1 is coupled to the reference node 110. The first terminal of the switch S2 is coupled to the second terminal 109 of the secondary winding T12, and the second terminal of the switch S2 is coupled to the reference node 110. In one embodiment, the switches Q1-Q4 and S1-S2 may comprise Metal Oxide Semiconductor Field Effect Transistor (MOSFET), Junction Field Effect Transistor (JFET), Insulated Gate Bipolar Transistor (IGBT), and other suitable transistor.

In one embodiment, the controller 30 is integrated in an integrated circuit (IC). The controller 30 comprises an output voltage sensing pin P1, an input voltage sensing pin P2, a plurality of control signal output pins P5-P8. The output voltage sensing pin P1 receives an output voltage sensing signal Vosen which represents the output voltage Vo. The input voltage sensing pin P2 receives an input voltage sensing signal Vinsen which represents the input voltage Vin. The control signal output pin P5 provides a switching control signal PWM1, the control signal output pin P6 provides a switching control signal PWM2, the control signal output pin P7 provides a switching control signal PWMS1, and the control signal output pin P8 provides a switching control signal PWMS2. In one embodiment, the switching control signal PWM1 is used to control the switches Q2 and Q3, e.g., turn on and off the switches Q2 and Q3, the switching control signal PWM2 is used to control the switches Q1 and Q4, e.g., turn on and off the switches Q1 and Q4, Q3, the switching control signal PWMS1 is used to control the switch S1, e.g., turn on and off the switch S1, and the switching control signal PWMS2 is used to control the switch S2, e.g., turn on and off the switch S2.

In one embodiment, the controller 30 is configured to turn on the switches Q2 and Q3 via transiting the switching control signal PWM1 to a first state based on the output voltage Vo and the switching control signal PWM2 and turn off the switch S2 via transiting the switching control signal PWMS2 to a second state. In one embodiment, the controller 30 is configured to turn on the switches Q1 and Q4 via transiting the switching control signal PWM2 to the first state based on the output voltage Vo and the switching control signal PWM1, and turn off the switch S1 via transiting the switching control signal PWMS1 to the second state. For example, the first state may comprise a high voltage level, and the second state may comprise a low voltage level. One with ordinary skill in the art should understand that the first state may also comprise the low voltage level to turn on a corresponding switch, and the second state may also comprise the high voltage level to turn off a corresponding switch without detracting merits of the present invention. In some examples, a voltage level between a high threshold voltage (e.g. 2V) and a voltage source (e.g. 3.3V) is considered as the high voltage level, a voltage level between zero voltage (0 V) and a low threshold voltage (e.g. 1V) is considered as the low voltage level. In one embodiment, the controller 30 is configured to provide the switching control signal PWMS2 based on the switching control signal PWM1, and provide the switching control signal PWMS1 based on the switching control signal PWM2. For example, when the switching control signal PWM1 transits to the second state, the switching control signal PWMS2 transits to the first state to turn on the switch S2 after a delay time period, and when the switching control signal PWM2 transits to the second state, the switching control signal PWMS1 transits to the first state to turn on the switch S1 after a delay time period. In one embodiment, when a time period that the switching control signal PWM1 in the first state is equal to a time period Ton1, or when an ON-time period of at least one of the switches Q2 and Q3 is equal to the time period Ton1, the controller 30 is configured to transits the switching control signal PWM1 to the second state to turn off the switches Q2 and Q3. In one embodiment, when a time period that the switching control signal PWM2 in the first state is equal to a time period Ton2, or when an ON-time period of at least one of the switches Q1 and Q4 is equal to the time period Ton2, the controller 30 is configured to transits the switching control signal PWM2 to the second state to turn off the switches Q1 and Q4. In one embodiment, the controller 30 is configured to control the time periods Ton1 and Ton2 based on the input voltage sensing signal Vinsen. For example, controlling the time periods Ton1 and Ton2 vary when the input voltage Vin changes.

In one embodiment, the controller 30 further comprises current sensing pins P3 and P4. The current sensing pin P3 is configured to receive a current sensing signal CS1, and the current sensing pin P4 is configured to receive a current sensing signal CS2. The current sensing signal CS1 represents a current flowing through the switch Q2, and the current sensing signal CS2 represents a current flowing through the switch Q4. In one embodiment, the controller 30 is configured to adjust at least one of the time periods Ton1 and Ton2, to balance the current flowing through the switch Q2 and the current flowing through the switch Q4, that is to balance the current flowing through the terminal 108 of the secondary winding T12 and the current flowing through the terminal 109 of the secondary winding T12. In one embodiment, the current sensing signal CS1 represents a current flows through a secondary side of the transformer T1 while the switch Q2 remains on, and the current sensing signal CS2 represents a current flows through the secondary side of the transformer T1 while the switch Q1 remains on.

In one embodiment, the controller 30 further comprises a remote return pin P0, which is combined with the output voltage sensing pin P1 to implement a remote sense of the output voltage Vo. As shown in FIG. 1A, the output voltage sensing pin P1 is coupled to a terminal of the output capacitor Co, and the remote return pin P0 is coupled to the other terminal of the output capacitor Co, a voltage across the the output voltage sensing pin P1 and the remote return pin P0 is the output voltage sensing signal Vosen. In another embodiment, the output voltage sensing pin P1 could also coupled to the terminal of the output capacitor Co via a resistor divider, while the remote return pin P0 is coupled to the other terminal of the output capacitor Co. In another embodiment, the contoller 30 could also sense the input voltage Vin via remote sensing (not shown in FIG. 1A).

The bridge switching converter, according to embodiments of the present invention, can achieve high output current and low output voltage, while maintaining good transient performance and output voltage accuracy. Additionally, it facilitates a balanced distribution of current and heat.

FIG. 1B schematically illustrates a bridge switching converter 100B in accordance with an embodiment of the present invention. Different from the bridge switching converter 100A shown in FIG. 1A, in the embodiment of FIG. 1B, the input capacitor Cin is coupled between the input node 101 and the output node 102, and a voltage across the input capacitor Cin is equal to the difference between the input voltage Vin and the output voltage Vo (Vin-VO).

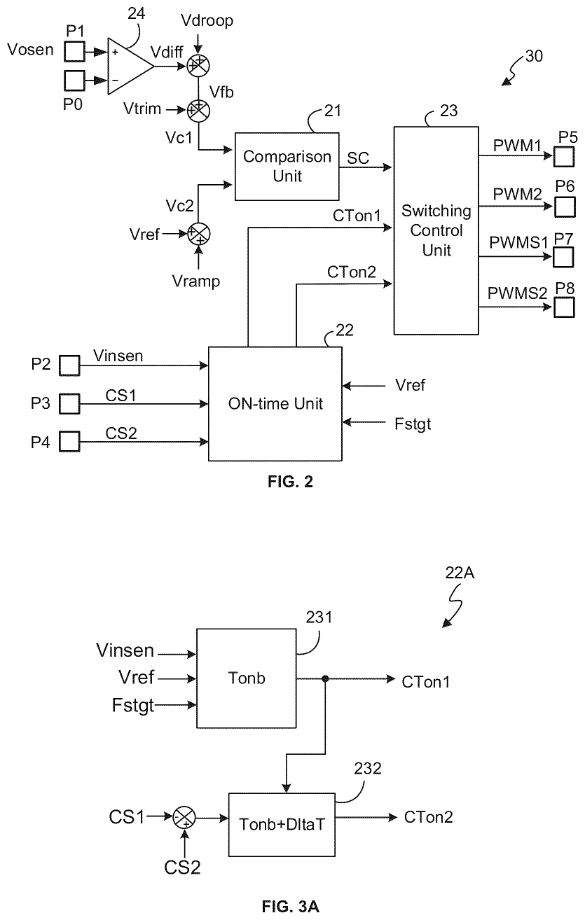

FIG. 2 schematically illustrates a controller 30 in accordance with an embodiment of the present invention. As shown in FIG. 2, the controller 30 comprises a comparison unit 21, an ON-time unit 22, and a switching control unit 23.

Referring to FIG. 2, the comparison unit 21 provides a comparison signal SC based on an output feedback signal Vfb and a reference signal Vref. In one embodiment, the controller 30 is configured to provide the output feedback signal Vfb based on the output voltage sensing signal Vosen. In one embodiment, when a signal Vc1 generated based on the feedback signal Vfb is less than a signal Vc2 generated based on the reference signal Vref, the comparison signal SC transits to the high voltage level to turn on at least one of the switches Q1-Q4. For example, when the feedback signal Vfb is less than the reference signal, the comparison signal SC transits to the high voltage level. For another example, when the feedback signal Vfb is less than a sum of the reference signal Vref and a slope compensation signal Vramp (Vref+Vramp), the comparison signal SC transits to the high voltage level. For another example, when a sum of the feedback signal Vfb and a bias signal Vtrim (Vfb+Vtrim) is less than the sum of the reference signal Vref and a slope compensation signal Vramp (Vref+Vramp), the comparison signal SC transits to the high voltage level. The bias signal Vtrim is used to reduce a static error between the output voltage Vo and a target output voltage set by the reference signal Vref. The slope compensation signal Vramp for example may be a periodically ramp with a period equal to half of a switching period, e.g., a time period between a rising edge of the switching control signal PWM1 to a riding edge of the switching control signal PWM2. In the embodiment of FIG. 2, the controller 30 further comprises a differential amplifier 24, two input terminals of the differential amplifier 24 is coupled to the remote return pin P0 and the output voltage sensing pin P1 respectively, and an output terminal of the differential amplifier 24 provides a differential signal Vdiff based on the output voltage sensing signal Vosen via a differential and amplification operation. The controller 30 is configured to provide the voltage feedback signal Vfb based on the differential signal Vdiff, e.g., the feedback signal Vfb may be equal to the differential signal Vdiff, or the feedback signal Vfb may be equal to a sum of the differential signal Vdiff and a droop signal Vdroop (Vdiff+Vdroop). The droop signal Vdroop represents a voltage drop of the output voltage Vo when an output current lo increases. The reference signal Vref may be set based on the target output voltage, e.g., set via a pin of the controller 30, set based on an initial data stored in the controller 30, or set by a user via a communication interface.

Continuing with FIG. 2, the ON-time unit 22 provides the ON-time control signals CTON1 and CTON2 based on the input voltage sensing signal Vinsen, the current sense signals CS1 and CS2, the reference signal Vref, and a target frequency signal Fstgt. The ON-time control signal CTON1 is used to control the time period Ton1, and the ON-time control signal CTON2 is used to control the time period Ton2. The target frequency signal Fstgt represents an expected frequency fs of a bridge switching converter (e.g., the bridge switching converter 100A or the bridge switching converter 100B). For example, the target frequency fs is an expected frequency of the switches Q1-Q4 under steady state of the bridge switching converter 100A or the bridge switching converter 100B. The target frequency signal Fstgt may be set via a pin of the controller 30, be set based on an initial data stored in the controller 30, or be set by the user via the communication interface. In one embodiment, the ON-time unit 22 controls the time periods Ton1 and Ton2 varying when the reference signal Vref or the target of the output voltage changes. In one embodiment, the ON-time unit 22 controls the time periods Ton1 and Ton2 varying when the frequency fs changes.

In the embodiment of FIG. 2, the switching control unit 23 provides the switching control signals PWM1, PWM2, PWMS1, and PWMS2 based on the comparison signal SC, the ON-time control signals CTon1 and CTon2. In one embodiment, according to the comparison signal SC, the switching control signals PWM1 and PWM2 alternately transition to the first state in turn, and the switching control signals PWMS1 and PWMS2 alternately transition to the second state in turn. In one embodiment, according to the ON-time control signal CTon1, the switching control signal PWM1 transitions to the second state, and the switching control signal PWMS2 transitions to the first state. In one embodiment, according to the ON-time control signal CTon2, the switching control signal PWM2 transitions to the second state, and the switching control signal PWMS1 transitions to the first state.

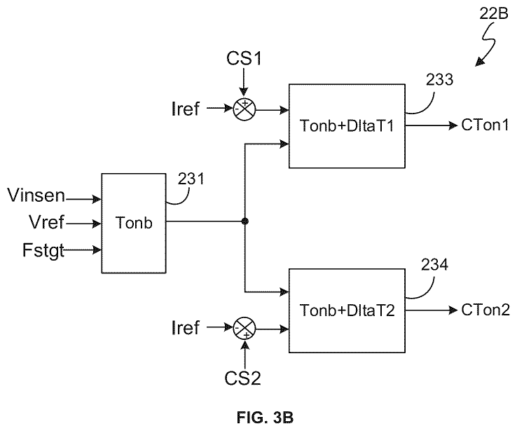

FIG. 3A schematically illustrates an ON-time unit 22A in accordance with an embodiment of the present invention. The ON-time unit 22A generates a base ON-time Tonb based on the input voltage sensing signal Vinsen, the reference signal Vref, the target frequency signal Fstgt, to control the time periods Ton1 and Ton2. In one example, the base ON-time Tonb is given in the following equation (1), and k is a scaling factor.

$$Tonb = \frac{k * V ref}{( V in - k * V ref ) Fstgt} \qquad ( 1 )$$

Further, in the embodiment of FIG. 3A, the ON-time unit 22A generates a adjusting time period DltaT to adjust at least one of the time periods Ton1 and Ton2, the adjusting time period DltaT may be positive, negative, or zero. FIG. 3A shows one example that the time period Ton1 is equal to the base ON-time Tonb, and the time period Ton2 is equal to a sum of the base ON-time Tonb and the adjusting time period DltaT.

Continuing with FIG. 3A, the ON-time unit 22A comprises a computing unit 231 and an adjusting unit 232. The computing unit 231 generates the base ON-time Tonb based on the equation (1) and provides the ON-time control signal CTon1 based on the base ON-time Tonb to control the time period Ton1. The adjusting unit 232 generates the adjusting time period DltaT based on a difference between the current sensing signals CS1 and CS2, and provides the ON-time control signal CTon2 based on the sum of the base ON-time Tonb and the adjusting time period DltaT (Tonb+DltaT) to control the time period Ton2.

FIG. 3B schematically illustrates an ON-time unit 22B in accordance with an embodiment of the present invention. In the embodiment of FIG. 3B, the ON-time unit 22B comprises the computing unit 231, an adjusting unit 233, and an adjusting unit 234. The adjusting unit 233 provides an adjusting signal DltaT1 based on a difference between the current sense signal CS1 and a current reference signal Iref (CS1−Iref), and provides the ON-time control signal CTon1 based on a sum of the base time period Tonb and the adjusting signal DltaT1 (Tonb+DIta1). The adjusting unit 234 provides an adjusting signal DltaT2 based on a difference between the current sense signal CS2 and the current reference signal Iref (CS2−Iref), and provides the ON-time control signal CTon2 based on a sum of the base time period Tonb and the adjusting signal DltaT2 (Tonb+DIta2). For example, the current reference signal Iref may be equal to an average of the current sensing signals CS1 and CS2, or a preset value. One with ordinary skill in the art should understand that the embodiments of FIGS. 3A-3B show examples of the ON-time unit 22, and detailed circuit structure of the ON-time unit 22 is not limited by the embodiments of FIGS. 3A-3B.

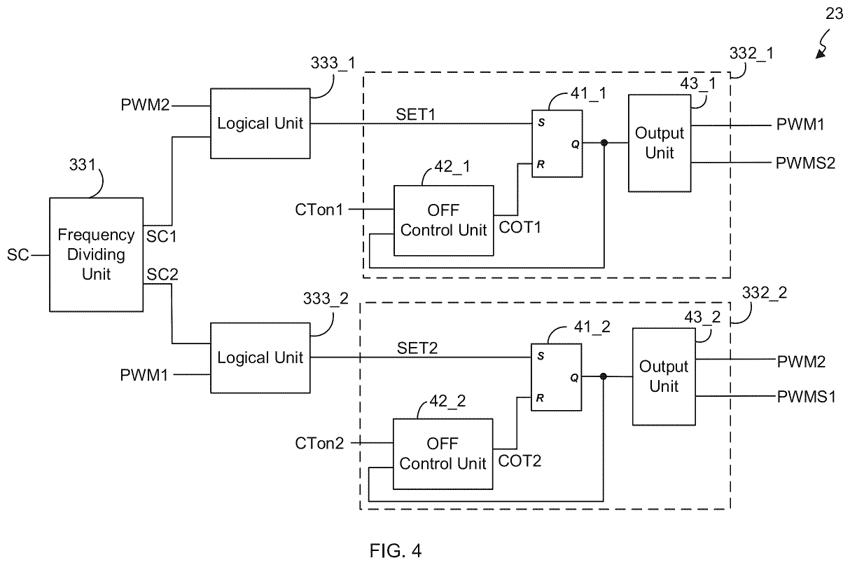

FIG. 4 schematically illustrates the switching control unit 23 in accordance with an embodiment of the present invention. In the embodiment of FIG. 4, the switching control unit 23 comprises a frequency dividing unit 331, a logical unit 333_1, a logical unit 333_2, a switching generating unit 332_1, and a switching generating unit 332_2.

As shown in FIG. 4, the frequency dividing unit 331 provides frequency dividing signals SC1 and SC2 based on the comparison signal SC. In one embodiment, the frequency dividing unit 331 distributes pulses of the comparison signal SC to the frequency dividing signals SC1 and SC2 in turn. The logical unit 333_1 provides a set signal SET1 to switch the switching control signal PWM1 to its first state and switch the switching control signal PWMS2 to its second state based on the frequency dividing signal SC1 and the switching control signal PWM2. For example, when the switching control signal PWM2 is the second state, the switching control signal PWMS2 switches to the second state according to the output voltage Vo, and then after a delay time period, the switching control signal PWM1 switches to the first state. The logical unit 333_2 provides a set signal SET2 to switch the switching control signal PWM2 to its first state and switch the switching control signal PWMS1 to its second state based on the frequency dividing signal SC2 and the switching control signal PWM1. For example, when the switching control signal PWM1 is the second state, the switching control signal PWMS1 switches to the second state according to the output voltage Vo, and then after the delay time period, the switching control signal PWM2 switches to the first state.

As shown in FIG. 4, the switching generating unit 332_1 provides the switching control signals PWM1 and PWMS2 based on the set signal SET1 and the ON-time control signal CTon1, and the switching generating unit 332_2 provides the switching control signals PWM2 and PWMS1 based on the set signal SET2 and the ON-time control signal CTon2. In one embodiment, the switching generating unit 332_1 switches the switching control signal PWM1 to the second state and switches the switching control signal PWMS2 to the first state based on the ON-time control signal CTon1, and the switching generating unit 332_2 switches the switching control signal PWM2 to the second state and switches the switching control signal PWMS1 to the first state based on the ON-time control signal CTon2.

In the embodiment of FIG. 4, the switching generating unit 332_1 comprises a RS flip-flop 41_1, an off control unit 42_1, and an output unit 43_1. The RS flip-flop 41_1 has a set terminal S, a reset terminal R and an output terminal Q, the set terminal S of the RS flip-flop 41_1 receives the set signal SET1, and the reset terminal R of the RS flip-flop 41_1 receives a reset signal COT1. The off control unit 42_1 provides the reset signal COT1 based on the ON-time control signal CTon1. The output unit 43_1 is coupled to the output terminal Q of the RS flip-flop 41_1, and provides the switching control signals PWM1 and PWMS2. In the embodiment of FIG. 4, the switching generating unit 332_2 comprises a RS flip-flop 41_2, an off control unit 42_2, and an output unit 43_2. The RS flip-flop 41_2 has a set terminal S, a reset terminal R and an output terminal Q, the set terminal S of the RS flip-flop 41_2 receives the set signal SET2, and the reset terminal R of the RS flip-flop 41_2 receives a reset signal COT2. The off control unit 42_2 provides the reset signal COT2 based on the ON-time control signal CTon2. The output unit 43_2 is coupled to the output terminal Q of the RS flip-flop 41_2, and provides the switching control signals PWM2 and PWMS1. One with ordinary skill in the art should understand that the embodiment of FIG. 4 shows one example of the switching control unit 23, and detailed circuit structure of the switching control unit 23 is not limited by the embodiment of FIG. 4.

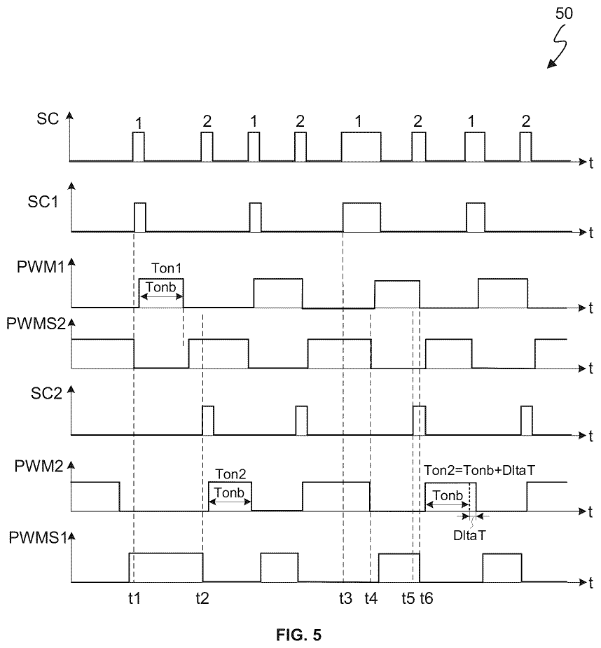

FIG. 5 schematically illustrates a timing diagram 50 of the switching control unit 23 of FIG. 4 in accordance with an embodiment of the present invention. The timing diagram 50 shows the comparison signal SC, the frequency dividing signal SC1, the switching control signal PWM1, the switching control signal PWMS2, the frequency dividing signal SC2, the switching control signal PWM2, and the switching control signal PWMS1 from top to below. In the embodiment of FIG. 5, a high voltage level of the switching control signals PWM1-PWM2, PWMS1-PWMS2 turns on a corresponding switch, and a low voltage level of the switching control signals PWM1-PWM2, PWMS1-PWMS2 turns off the corresponding switch.

As shown in FIG. 5, the comparison signal SC becomes the high voltage level based on the output voltage Vo. For example, when the signal Vc1 generated based on the feedback signal Vfb is less than the signal Vc2 generated based on the reference signal Vref, the comparison signal SC is set to the high voltage level. In response to the high voltage level of the comparison signal SC, the switching control signals PWM1 and PWM2 are alternately set to the high voltage level, and the switching control signals PWMS2 and PWMS1 are alternately set to the low voltage level. As shown in FIG. 5, the pulses of the comparison signal SC are sequentially distributed to the frequency dividing signals SC1-SC2. For example, the pulses labelled “1” are distributed to the frequency dividing signal SC1, while the pulses labelled “2” are distributed to the frequency dividing signal SC2. When the switching control signal PWM2 is at the low voltage level, the switching control signal PWMS2 transitions to the low voltage level and the switching control signal PWM1 transitions to the high voltage level in response to the pulses of the frequency dividing signal SC1. When the switching control signal PWM1 is at the low voltage level, the switching control signal PWMS1 transitions to the low voltage level and the switching control signal PWM2 transitions to the high voltage level in response to the pulses of the frequency dividing signal SC2.

As shown in FIG. 5, at time t1, the switching control signal PWM2 is at the low voltage level, the frequency dividing signal SC1 becomes the high voltage level based on the output voltage Vo, and the switching control signal PWMS2 transitions to the low voltage level and the switching control signal PWM1 transitions to the high voltage level after the delay time period. The switching control signal PWM1 transitions to the low voltage level until a time period that the switching control signal PWM1 maintains at the high voltage level reaches the time period Ton1, and then the switching control signal PWMS2 transitions to the high voltage level after the delay time period. At time t2, the switching control signal PWM1 is at the low voltage level, the frequency dividing signal SC2 becomes the high voltage level based on the output voltage Vo, and the switching control signal PWMS1 transitions to the low voltage level and the switching control signal PWM2 transitions to the high voltage level after the delay time period. The switching control signal PWM2 transitions to the low voltage level until a time period that the switching control signal PWM2 maintains at the high voltage level reaches the time period Ton2, and then the switching control signal PWMS1 transitions to the high voltage level after the delay time period. In one embodiment, when the current sensing signals CS1 and CS2 are equal to each other, the time periods Ton1 and Ton2 will be equal to the base time period Tonb.

Continuing with FIG. 5. At time t3, the frequency dividing signal SC1 becomes the high voltage level but the switching control signal PWM2 remains at the high voltage level, as a result, both the switching control signals PWM1 and PWMS2 maintain their respective voltage levels, e.g., low for the switching control signal PWM1, and high for the switching control signal PWMS2. Until time t4, the switching control signal PWM2 is at the low voltage level, the switching control signal PWMS2 transitions to the low voltage level, and the switching control signal PWM1 transitions to the high voltage level after the delay time period. In one embodiment, when the current sensing signals CS1 and CS2 are not equal, the time period Ton2 is equal to the sum of the base time period Tonb and the adjusting time period DltaT. At time t5, the frequency dividing signal SC2 becomes the high voltage level but the switching control signal PWM1 remains at the high voltage level, as a result, both the switching control signals PWM2 and PWMS1 maintain their respective voltage levels, e.g., low for the switching control signal PWM2, and high for the switching control signal PWMS1. Until time t6, the switching control signal PWM1 is at the low voltage level, the switching control signal PWMS1 transitions to the low voltage level, and the switching control signal PWM2 transitions to the high voltage level after the delay time period.

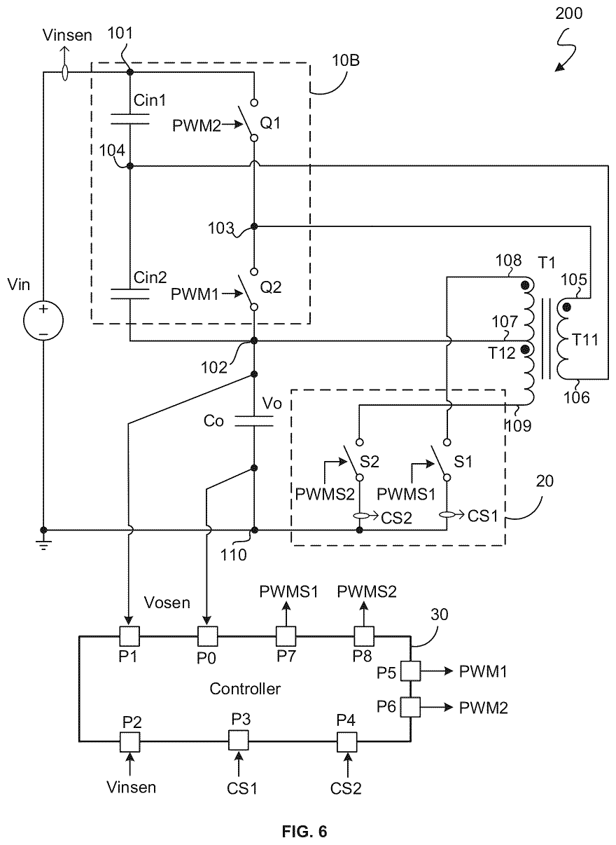

FIG. 6 schematically illustrates a bridge switching converter 200 in accordance with an embodiment of the present invention. Different from the bridge switching converter 100A of FIG. 1A, in the embodiment of FIG. 6, the primary switching circuit 10B comprises a half-bridge circuit having capacitors Cin1 and Cin2, and switches Q1, and Q2. The capacitors Cin1 and Cin2 are coupled in series between the input node 101 and the output node 102. A first terminal of the capacitor Cin1 is coupled to the input node 101, a first terminal of the capacitor Cin2 is coupled to a second terminal of the capacitor Cin1 to form the bridge terminal 104, and a second terminal of the capacitor Cin2 is coupled to the output node 102. The input node 101 is used as a first input of the primary switching circuit 10B, and the output node 102 is used as a second input of the primary switching circuit 10B.

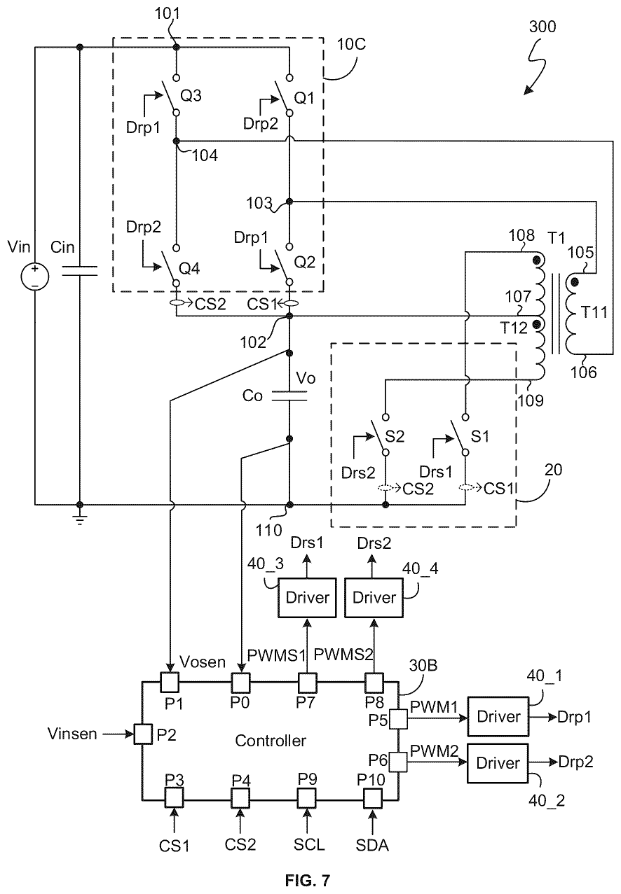

FIG. 7 schematically illustrates a bridge switching converter 300 in accordance with an embodiment of the present invention. In the embodiment of FIG. 7, a controller 30B further comprises communication pins P9 to P10 for communicating with a host device to receive user settings. In one embodiment, the controller 30B is integrated in the IC. In the embodiment of FIG. 7, the communication pin P9 is coupled to a clock bus SCL and the communication pin P10 is coupled to a data bus SDA. In the embodiment of FIG. 7, the bridge switching converter 300 further comprises drivers 40_1-40_4. The driver 40_1 receives the switching control signal PWM1 and provides a drive signal Drp1 according to the switching control signal PWM1 to drive the switches Q2 and Q3. The driver 40_2 receives the switching control signal PWM2, and provides a drive signal Drp2 according to the switching control signal PWM2 to drive the switches Q1 and Q4. The driver 40_3 receives the switching control signal PWMS1 and provides a drive signal Drs1 according to the switching control signal PWMS1 to drive the switch S1. The driver 40_4 receives the switching control signal PWMS2 and provides a drive signal Drs2 according to the switching control signal PWMS2 to drive the switch S2. In one embodiment, the drives 40_1-40_4 are integrated on different ICs respectively. In another embodiment, the drives 40_1 and 40_2 can be integrated on the same IC, and the drives 40_3 and 40_4 can be integrated on the same IC.

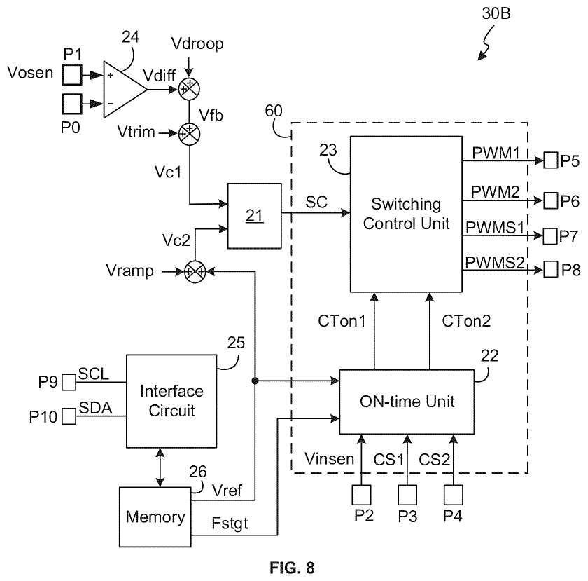

FIG. 8 schematically illustrates a controller 30B in accordance with an embodiment of the present invention. In the embodiment of FIG. 8, the controller 30B further comprises an interface circuit 25 and a memory 26. The controller 30B receives an updated data sent by the host via the communication pins P9 and P10, and the memory 26 is used to store the updated data received from the host via the communication pins P9 and P10, as well as being used to initially store an initial data. The initial data may comprise factory settings. The controller 30B provides the reference signal Vref and the target frequency signal Fstgt according to the updated data received via the communication pins P9 and P10 or according to the initial data stored in the memory 26. In one embodiment, the controller 30B is initially configured to control the time period Ton1 and the time period Ton2 based on the initial data, and the controller 30B is configured to control the time period Ton1 and the time period Ton2 when receiving the updated data via the communication pins P9-P10.

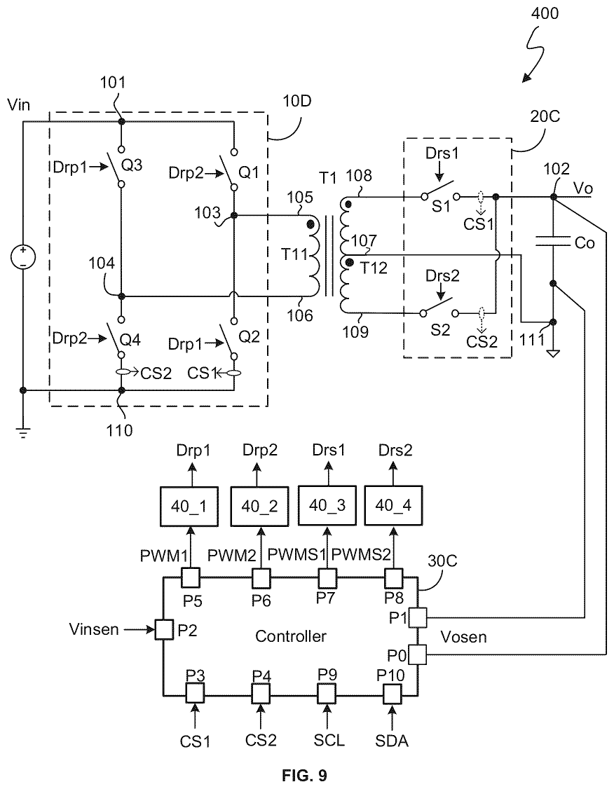

FIG. 9 schematically illustrates a bridge switching converter 400 in accordance with an embodiment of the present invention. In the embodiment of FIG. 9, the bridge switching converter 400 comprises a primary switching circuit 10D, the transformer T1, a secondary switching circuit 20C, and a controller 30C. In one embodiment, the controller 30C is integrated in the IC. The primary switching circuit 10D comprises switches Q1-Q4. Different from the primary switching circuit 10C, the second terminal of the switch Q2 and the second terminal of the switch Q4 are coupled to the reference node 110. The center-tap 107 of the secondary winding T12 is coupled to a reference node 111. The reference node 111 can also be coupled to the reference node 110. The secondary switching circuit 20C is different from the secondary side switching circuit 20B in that the second terminal of the switch S1 and the second terminal of switch S2 are coupled to the output node 102.

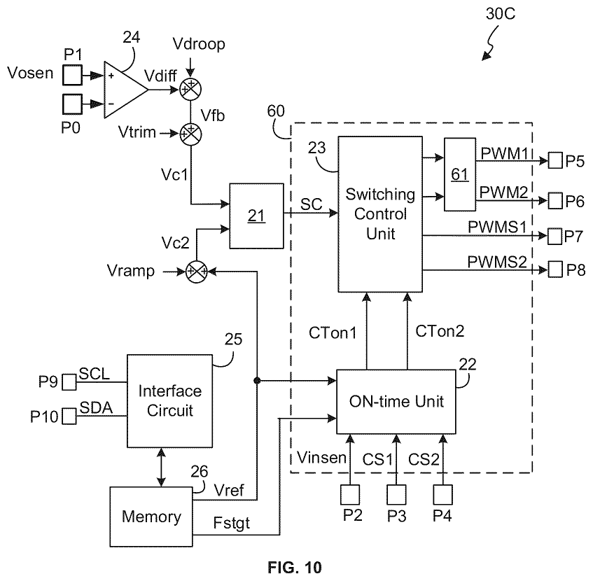

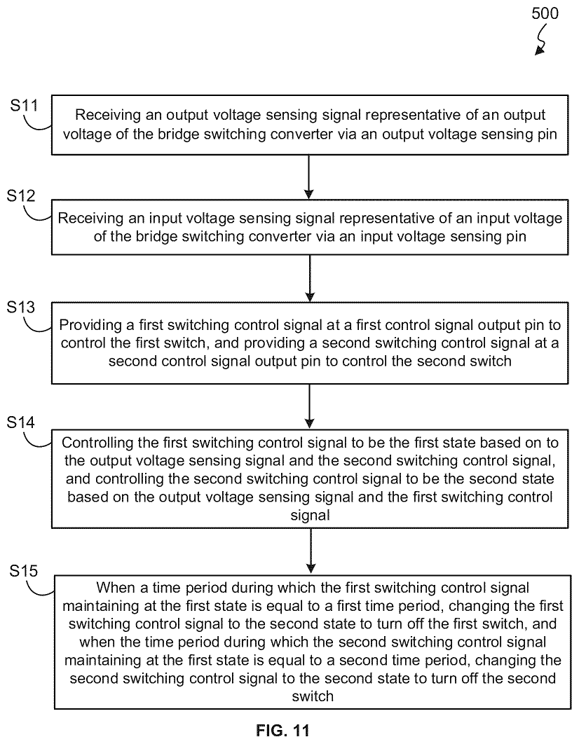

FIG. 10 schematically illustrates the controller 30C of FIG. 9 in accordance with an embodiment of the present invention. As shown in FIG. 10, the controller 300 further comprises an isolation circuit 61, which is coupled between the switching control unit 23 and the control signal output pins P5-P6, so that the switching control signals PWM1 and PWM2 are isolated from the secondary side of the transformer T1. The isolation circuit 61 comprises, for example, an isolation capacitor.

FIG. 11 illustrates a control method 500 for a bridge switching converter in accordance with an embodiment of the present invention. The bridge switching converter comprises a transformer, a primary side circuit coupled to a primary winding of the transformer, and a secondary side circuit coupled to a secondary winding of the transformer. The primary side circuit comprises at least a first and a second switches. The control method 500 comprises steps S11 to S15.

In step S11, receiving an output voltage sensing signal representative of an output voltage of the bridge switching converter via an output voltage sensing pin. In step S12, receiving an input voltage sensing signal representative of an input voltage of the bridge switching converter via an input voltage sensing pin. In step S13, providing a first switching control signal at a first control signal output pin to control the first switch, and providing a second switching control signal at a second control signal output pin to control the second switch. In step S14, controlling the first switching control signal to be the first state based on to the output voltage sensing signal and the second switching control signal, and controlling the second switch control signal to be the second state based on the output voltage sensing signal and the first switching control signal. In step S15, when a time period during which the first switching control signal maintaining at the first state is equal to a first time period, changing the first switching control signal to the second state to turn off the first switch, and when the time period during which the second switching control signal maintaining at the first state is equal to a second time period, changing the second switching control signal to the second state to turn off the second switch.

Note that in the control methods described above, the functions indicated in the boxes can also occur in different orders than those shown in FIG. 11. Fox example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A bridge switching converter, comprising:
an input node configured to receive an input voltage;
an output node configured to provide an output voltage;
a transformer comprising a primary winding and a secondary winding, the primary winding having a first terminal and a second terminal, and the secondary winding having a first terminal, a second terminal, and a center-tap positioned between the first and second terminals of the secondary winding, wherein the center-tap is coupled to the output node;
a first switch having a first terminal and a second terminal, wherein the first terminal of the first switch is coupled to the input node, and the second terminal of the first switch is coupled to the first terminal of the primary winding;
a second switch having a first terminal and a second terminal, wherein the first terminal of the second switch is coupled to the second terminal of the first switch and the first terminal of the primary winding, the second terminal of the second switch is coupled to the center-tap of the secondary winding, and the first switch and the second switch forms a first bridge branch;
a third switch having a first terminal and a second terminal, wherein the first terminal of the third switch is coupled to the input node, and the second terminal of the third switch is coupled to the second terminal of the primary winding;
a fourth switch having a first terminal and a second terminal, wherein the first terminal of the fourth switch is coupled to the second terminal of the third switch and the second terminal of the primary winding, the second terminal of the fourth switch is coupled to the center-tap of the secondary winding, and the third switch and the fourth switch forms a second bridge branch;
a fifth switch having a first terminal and a second terminal, wherein the first terminal of the fifth switch is coupled to the first terminal of the secondary winding, and the second terminal of the fifth switch is coupled to a reference node;
a sixth switch having a first terminal and a second terminal, wherein the first terminal of the sixth switch is coupled to the second terminal of the secondary winding, and the second terminal of the sixth switch is coupled to the reference node; and
a controller configured to provide a first switching control signal to control the second and third switches, provide a second switching control signal to control the first and fourth switches, provide a third switching control signal to control the fifth switch, and provide a fourth switching control signal to control the sixth switch; wherein
when the first and fourth switches are off, the controller is configured to turn on the second and third switches based on the output voltage via the first switching control signal, and the controller is configured to turn off the second and third switches until an ON-time period of the third switch or an ON-time period of the fourth switch reaches a first time period; and
when the second and third switches are off, the controller is configured to turn on the first and fourth switches based on the output voltage via the second switching control signal, and the controller is configured to turn off the first and fourth switches until an ON-time period of the first switch or an ON-time period of the fourth switch reaches a second time period.

2. The bridge switching converter of claim 1, wherein the controller is configured to adjust at least one of the first and second time periods to balance a first current flowing through the first bridge branch and a second current flowing through the second bridge branch.

3. The bridge switching converter of claim 2, wherein the controller is further configured to control the first and second time periods varying when the input voltage varies.

4. The bridge switching converter of claim 1, wherein the controller is configured to turn off the fifth switch via the third switching control signal based on the first switching control signal and the output voltage, and the controller is configured to turn on the fifth switch via the third switching control signal based on the ON-time period of the first switch or the ON-time period of the fourth switch.

5. The bridge switching converter of claim 1, wherein the controller is configured to turn off the sixth switch via the fourth switching control signal based on the second switching control signal and the output voltage, and the controller is configured to turn on the sixth switch via the fourth switching control signal based on the ON-time period of the second switch or the ON-time period of the third switch.

6. The bridge switching converter of claim 1, wherein the controller comprises:
a comparison unit configured to provide a comparison signal based on an output voltage sensing signal and a reference signal, wherein the output voltage sensing signal represents the output voltage;
an ON-time unit configured to provide a first ON-time control signal and a second ON-time control signal based on the input voltage, a first current sensing signal and a second current sensing signal, wherein the first current sensing signal represents a current flowing through the first bridge branch, and the second current sensing signal represents a current flowing through the second bridge branch; and
a switching control unit configured to provide the first and fourth switching control signals based on the comparison signal, the first ON-time control signal and the second switching control signal, and provide the second and third switching control signals based on the comparison signal, the second ON-time control signal and the first switching control signal.

7. A bridge switching converter, comprising:
an input node, an output node, and a reference node, wherein the bridge switching converter is configured to receive an input voltage between the input node and the reference node, and is configured to provide an output voltage between the output node and the reference node;
a transformer having a primary winding and a secondary winding, the primary winding having a first terminal and a second terminal, the secondary winding having a first terminal, a second terminal, and a center-tap positioned between the first and second terminals of the secondary winding;
a primary switching circuit having a first input terminal, a second input terminal, a first bridge terminal, a second bridge terminal, a first switch, and a second switch, wherein the first input terminal of the primary switching circuit is coupled to the input node, the second input terminal of the primary switching circuit is coupled to the output node, the first bridge terminal is coupled to the first terminal of the primary winding, the second bridge terminal is coupled to the second terminal of the primary winding, the center-tap is coupled to the second input terminal of the primary switching circuit, the second switch is coupled between the first bridge terminal and the output node, and the first switch is coupled between the input node and the first bridge terminal; and
a controller configured to provide a first switching control signal to control the second switch and provide a second switching control signal to control the first switch based on the output voltage, wherein when the first switch remains off, the controller is configured to turn on the second switch based on the output voltage via the first switching control signal, and when the second switch remains off, the controller is configured to turn on the first switch based on the output voltage via the second switching control signal.

8. The bridge switching converter of claim 7, further comprising:
a third switch and a fourth switch, a first terminal of the third switch is coupled to the first terminal of the secondary winding, a second terminal of the third switch is coupled to the reference node, a first terminal of the fourth switch is coupled to the second terminal of the secondary winding, and a second terminal of the fourth switch is coupled to the reference node.

9. The bridge switching converter of claim 8, wherein:
the controller is configured to turn off the third switch in response to a state of the first switching control signal and the output voltage via a third switching control signal, and is configured turn on the third switch in response to the state of the second switching control signal via the third switching control signal; and
the controller is configured to turn off the fourth switch in response to a state of the second switching control signal and the output voltage via a fourth switching control signal, and is configured to turn on the fourth switch in response to the state of the first switching control signal via the fourth switching control signal.

10. The bridge switching converter of claim 7, wherein when an ON-time period of the first switch reaches a first time period, the controller is configured to turn off the first switch via the second switching control signal, and when an ON-time period of the second switch reaches a second time period, the controller is configured to turn off the second switch via the first switching control signal.

11. The bridge switching converter of claim 10, wherein the controller is configured to adjust at least one of the first and second time periods to balance a first current and a second current, wherein the first current flows through a secondary side of the transformer while the second switch remains on, and the second current flows through the secondary side of the transformer while the first switch remains on.

12. The bridge switching converter of claim 7, wherein the controller comprises:
a comparison unit configured to provide a comparison signal based on an output voltage sensing signal and a reference signal, wherein the output voltage sensing signal represents the output voltage;
an ON-time unit configured to provide a first ON-time control signal and a second ON-time control signal based on the input voltage, a first current sensing signal and a second current sensing signal, wherein the first current sensing signal represents a first current flows through a secondary side of the transformer while the second switch remains on, and the second current sensing signal represents a second current flows through the secondary side of the transformer while the first switch remains on; and
a switching control unit configured to provide the first switching control signal based on the comparison signal, the first ON-time control signal and the second switching control signal, and provide the second switching control signal based on the comparison signal, the second ON-time control signal and the first switching control signal.

13. The bridge switching converter of claim 7, wherein the second bridge terminal is coupled to the input node through a first capacitor or a fifth switch, and is coupled to the output node through a second capacitor or a sixth switch.

14. An integrated circuit (IC) as a controller of a bridge switching converter, comprising:
an output voltage sensing pin configured to receive an output voltage sensing signal, wherein the output voltage sensing signal represents an output voltage of the bridge switching converter;
an input voltage sensing pin configured to receive an input voltage sensing signal, wherein the input voltage sensing signal represents an input voltage of the bridge switching converter;
a first control signal output pin configured to provide a first switching control signal to control a first switch positioned at a primary side of a transformer of the bridge switching converter;
a second control signal output pin configured to provide a second switching control signal to control a second switch positioned at the primary side of the transformer;
a third control signal output pin configured to provide a third switching control signal to control a third switch positioned at a secondary side of the transformer; and
a fourth control signal output pin configured to provide a fourth switching control signal to control a fourth switch positioned at the secondary side of the transformer; wherein
when the second switch is off, the IC is configured to turn on the first switch based on the output voltage via the first switching control signal, and the IC is configured to turn off the first switch via the first switching control signal until an ON-time period of the first switch reaches a first time period; and wherein
when the first switch is off, the IC is configured to turn on the second switch based on the output voltage via the second switching control signal, and the IC is configured to turn off the second switch via the second switching control signal until an ON-time period of the second switch reaches a second time period.

15. The IC of claim 14, further comprising:
a first current sensing pin configured to receive a first current sensing signal representative of a current flowing through the third switch; and
a second current sensing pin configured to receive a second current sensing signal representative of a current flowing through the fourth switch; wherein
the IC is configured to adjust at least one of the first time period and the second time period based on the first current sensing signal and the second current sensing signal to balance the current flowing through the third switch and the current flowing through the fourth switch.

16. The IC of claim 15, further comprising:
a communication pin configured to receive an updated data; and
a memory configured to store the updated data received via the communication pin, wherein an initial data is initially stored in the memory; wherein
the IC is initially configured to control the first time period and the second time period based on the initial data, and the IC is configured to control the first time period and the second time period when receiving the updated data via the communication pin.

17. The IC of claim 15, further comprising:
a comparison unit configured to provide a comparison signal based on the output voltage sensing signal and a reference signal;
an ON-time unit configured to provide a first ON-time control signal and a second ON-time control signal based on the input voltage sensing signal, the first current sensing signal and the second current sensing signal; and
a switching control unit configured to provide the first and fourth switching control signals based on the comparison signal, the first ON-time control signal, and the second switching control signal, and provide the second and third switching control signals based on the comparison signal, the second ON-time control signal, and the first switching control signal.

18. The IC of claim 17, wherein the comparison signal changes its state when a first signal is less than a second signal, the first signal is generated based on the voltage sensing signal and a droop signal representative of a voltage drop of the output voltage when an output current of the bridge switching converter increases, and the second signal is generated based on the reference signal.

19. The IC of claim 14, wherein the IC is configured to turn off the third switch via the third switching control signal based on the first switching control signal and the output voltage, and the IC is configured to turn on the third switch via the third switching control signal based on the second switching control signal.

20. The IC of claim 14, wherein the IC is configured to turn off the fourth switch via the fourth switching control signal based on the second switching control signal and the output voltage, and the IC is configured to turn on the fourth switch via the fourth switching control signal based on the first switching control signal.
